(19) United States
(12) Patent Application Publication
(10) Pub. No.: US 2014/0198673 A1
(43) Pub. Date: Jul. 17, 2014

(54) ACCESS POINT

(71) Applicant: HEWLETT-PACKARD DEVELOPMENT COMPANY, L.P., Houston, TX (US)

(72) Inventors: Michael Farinaccio, Vimont (CA); Andre Beaudin, Montreal (CA)

(73) Assignee: Hewlett-Packard Development Company, L.P., Houston, TX (US)

(21) Appl. No.: 13/744,026

(22) Filed: Jan. 17, 2013

(51) Int. Cl. H04W 88/08; H04W 24/00

(52) U.S. Cl. CPC H04W 88/08; H04W 24/00
USPC 370/252

(57) ABSTRACT

Techniques for access point (AP) operation with respect to a client device are described in various implementations. In one example implementation, a method may include receiving, at an AP, a packet from a client device which was previously disconnected from the AP and has re-connected to the access point. The AP may obtain the SNR of the packet and determine whether to remain connected with the client device or re-disconnect the client device based at least in part on the SNR or the packet.

### BACKGROUND

In computer networking environments, a wireless access point (AP) is a device that allows wireless client devices such as laptops, tablets, and smartphones to connect to a wired network using the Institute of Electrical and Electronics Engineers (IEEE) 802.11 standard, or related standards. This enables the client devices to access network devices such as web servers, database servers, file servers, email servers, and the like without having a wired connection. In particular, a connection is setup via radio frequency (RF) links between the AP and the client devices, and wired links between the AP and the network devices.

In some architectures, such as those implemented in business campuses or educational campuses, a plurality of APs are spread throughout a geographic area, and each AP generally services the client devices in the geographic area proximate to the AP. In the case when a client device roams beyond the geographic area serviced by one AP, service is typically handed off to another AP that services the geographic area the client device has entered.

### BRIEF DESCRIPTION OF THE DRAWINGS

Examples are described in the following detailed description and in reference to the drawings, in which:

FIG. 1 depicts an example system including an access point and a client device in accordance with an implementation;

FIG. 2 depicts an example process flow diagram for processes conducted at the AP in accordance with an implementation;

FIG. 3 depicts another example process flow diagram for processes conducted at the AP in accordance with an implementation; and

FIG. 4 depicts an example access point in accordance with an implementation,

### DETAILED DESCRIPTION

Various aspects of the present disclosure are directed to AP communication control. In particular, various aspects of the present disclosure are directed to techniques conducted an the AP to control client device connections with the AP

As discussed in the foregoing, in IEEE 802.11 networks, roaming typically occurs when a client device travels beyond the geographic area serviced by one AP, and service is handed off to another AP Unlike cellular networks where handoff decisions are coordinated by the network, in IEEE 802.11 networks, the client device is responsible for scanning other communication channels to determine if there is a closer AP to connect to. While this scanning by the client device lowers the burden on the network infrastructure, it comes at a price because the scanning increases the depletion rate of the client device's battery. This is viewed as a significant negative because battery life is deemed very important in our mobile society. As a result, there has been a recent increase in client devices that avoid scanning other communication channels until the signal from the AP is dropped or not reachable anymore. That is, for example, a laptop may avoid scanning other communication channels until it loses communication with an AP. While this approach tends to conserve battery life such that the client device can operate for longer periods without charging, it leads to the client device staying connected to far away APs when there are closer APs available to connect to. This, in turn, leads to the client device unnecessarily dealing with poor signal quality at the expense of longer battery life. Often times, even if a user would like to reverse this client device setting, the user cannot because the setting is part of the client device's default programming.

Aspects of the present disclosure address at least the above-mentioned issues by providing a technique that attempts to forces client devices to connect to closer APs even if the client device refrains from scanning other channels until a signal from the AP is dropped or not reachable anymore. That is, even if the user cannot reverse the client device's scanning protocol, aspects of the present disclosure attempt to force the client device to connect to closer APs. This is generally accomplished by novel and previously unforeseen processes conducted at the AP which attempts to dictate client device behavior based at least in part on the measured signal-to-noise ratio (SNR) of packets received from the client device. In particular, the AP generally disconnects client devices with SNR levels below a predetermined threshold, and only allows the client devices to reconnect and stay connected if particular conditions are met—namely, a SNR level above the predetermined threshold, or a SNR level below the predetermined threshold but within an acceptable delta value when compared to the earlier measured SNR level. Hence, the approach pushes client devices with alternative options to switch APs, but at the same time accommodates client devices that may not have alternative options (e.g., the client device is far from the AP but is in an area where it cannot switch to another AP).

In one example implementation, a process is provided. The process includes receiving, at an AP, a first packet from a client device. The AP then disconnects the client device in response to determining that a SNR associated with at least the first packet is below a predetermined SNR threshold. Thereafter, in response to the client device re-connecting with the AP, the AP receives a second packet from the client device and disconnects the client device in response to determining that (i) a SNR associated with at least the second packet is below the predetermined SNR threshold, and (ii) the absolute difference between the SNR associated with at least the second packet and the SNR associated with at least the first packet is above a predetermined delta value.

In another example implementation, an AP is provided. The AP comprises a communication interface, a measuring module, and a communication management module. The communication interface to receive a packet from a client device which was previously disconnected from the AP and has re-connected to the AP. The measuring module is to measure a SNR of the packet. The communication management module is to obtain the SNR of the packet from the measuring module, and (i) if the SNR of the packet is above a predetermined SNR threshold, continue communication with the client device; (ii) if the SNR of the packet is below the predetermined SNR threshold, and if the absolute difference between the SNR of the packet and an earlier SNR is less a predetermined delta value, continue communication with the client device; and (iii) if the SNR of the packet is below the predetermined SNR threshold, and if the absolute difference between the SNR of the packet and the earlier SNR is above a predetermined delta value, disconnect the client device from the AP

In yet another example implementation, a non-transitory computer-readable medium is provided. The non-transitory computer-readable medium comprises instructions that when executed cause an access point to compare a measured SNR associated with at least a first packet with a predetermined SNR threshold, and disconnect the client device in response to determining that the measured SNR associated with at least the first packet is below the predetermined SNR threshold. Moreover, the instructions are to compare a measured SNR associated with at least a second packet with the predetermined SNR threshold (wherein the second packet is received from the client device in response to the client device re-connecting with the AP), and disconnect the client device in response to determining that (i) the measured SNR associated with at least the second packet is below the predetermined SNR threshold, and (ii) the absolute difference between the measured SNR associated with at least the second packet and the SNR associated with at least the first packet is above a predetermined delta value.

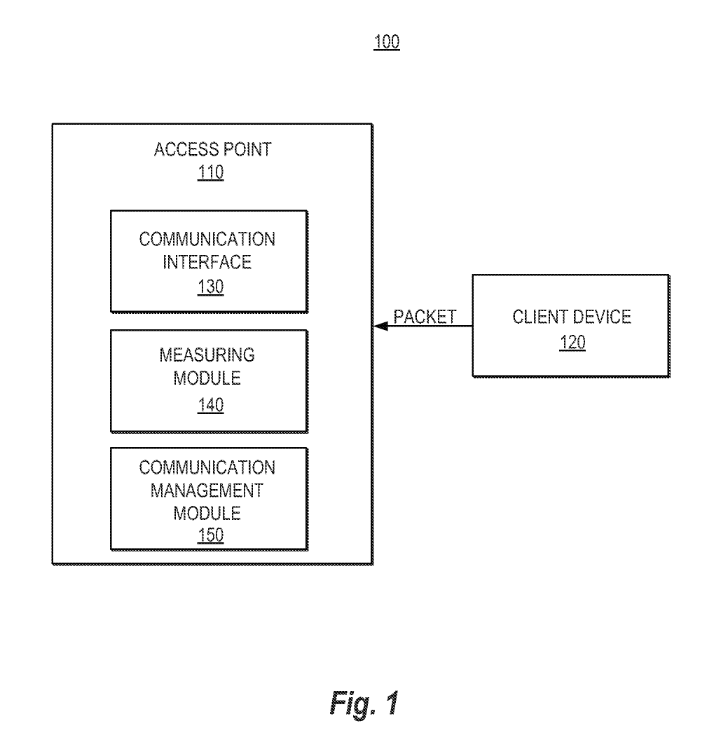

FIG. 1 depicts an example system 100 in accordance with an implementation. It should be readily apparent that the system 100 represents a generalized illustration and that other elements may be added or existing elements may be removed, modified, or rearranged without departing from the scope of the present disclosure. For example, while the system 100 depicted in FIG. 1 includes only one AP 110 and one client device 120, the system 100 may actually comprise a plurality of APs and client devices, and only one of each has been shown and described for simplicity.

The client device is FIG. 1 may be generally understood as a wireless communication device. For example, the client device may be a laptop, tablet, FDA, gaming device, smartphone, navigation device, or the like. The AP 110 generally enables the client device 120 to connect to a wired network (not shown) and have access to network devices (not shown) such as web servers, database servers, file servers, email servers, etc. The connection between the AP 110 and the client device 120 is via a RF link, and this RF link enables bi-directional traffic comprising packets (i.e., data packets, frame packets, etc.) to flow between the AP 110 and the client device 120. Furthermore, this connection may be commensurate with the IEEE 802.11 set if standards for implementing a wireless local area network (WLAN).

The AP 110 comprises a communication interface 130, a measuring module 140, and a communication management module 150. While the communication interface 130 generally comprises hardware components (transceivers, PHYs, ports, etc.), the measuring module 140 and communication management module 150 may comprise hardware, software, or a combination of both. For example, in some implementations, the modules comprise memory encoded with instructions that when executed by a processing device cause the AP to conduct functions described herein. Alternatively or in addition, the modules may comprise functionally equivalent hardware to conduct functions described herein,

The communication interface 130 is to transmit and receive packets from the client device(s) 120 as well as other network devices. Such packets may comprise at least the types of information described throughout this disclosure. The communication interface 130 may comprise one or more components such as, for example, transmitters, receivers, transceivers, antennas, ports, and/or PHYs. It should be understood that the communication interface 130 may comprise multiple interfaces and that each may serve a different purpose (e.g., to interface with the client device 120, to interface with the wired infrastructure, etc.).

The measuring module 140 is to receive packets from the communication interface 130 and measure the SNR of each packet or measure the SNR of a specific subset of packets (e.g., only data packets). The packets may comprise, for example, association requests, re-association requests, probe requests, authentication packets, RTS packets, ACK packets, and/or data packets. The measuring module 140 may measure the SNR of each packet by, for example, comparing the level of a desired signal to the level of background noise (i.e., the ratio of signal power to the noise power). More particularly, the measuring module may scan the environment to determine the current noise level, and further determine the signal level for each packet. The SNR may then be determined for each packet based on the determined noise level and the determined signal level. The measuring module 140 may comprise or have access to an association table for each client device, and store the determined SNR for each packet in the table.

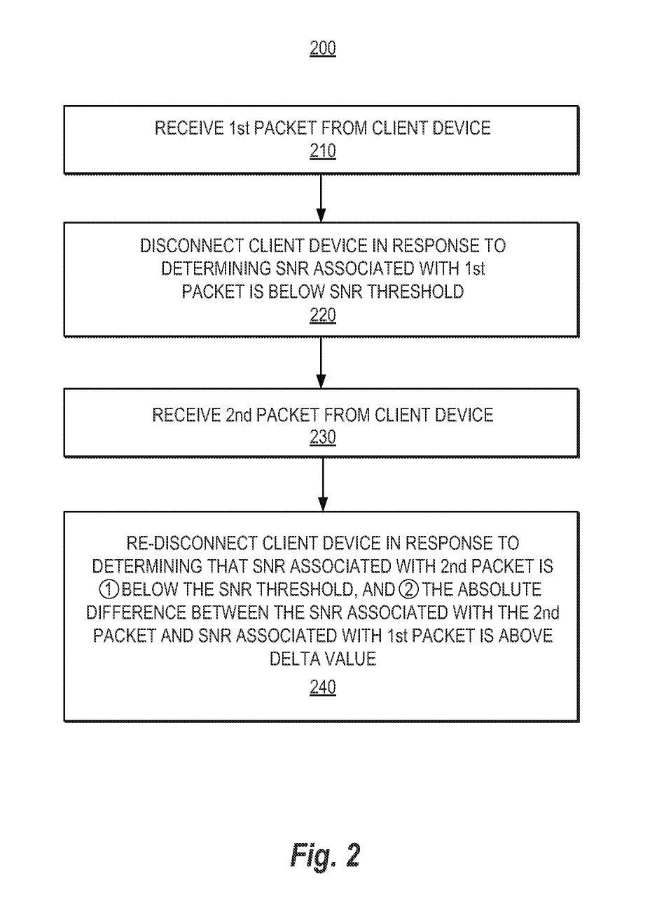

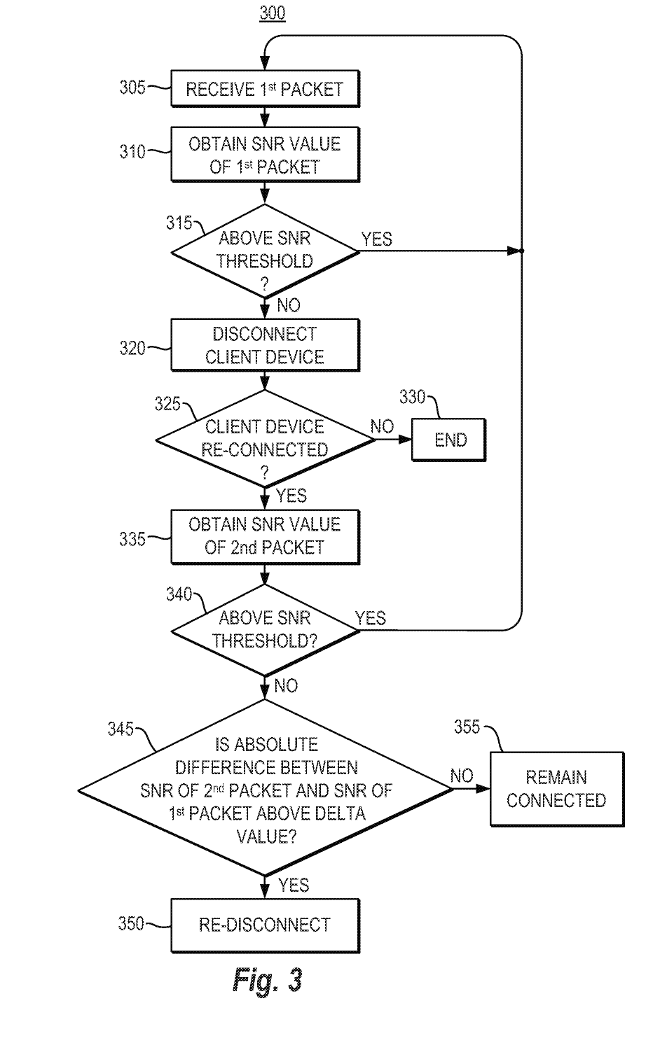

The communication management module 150 is to obtain the SNR levels from the measuring module. Depending on the implementation, the SNR level may be for one packet, multiple packets, or an average SNR based on the measurement of multiple packets. As mentioned above, this information may come from a table within or accessible by the measuring module 140. Moreover, this information may be obtained by the communication management module 150 continuously, periodically, or in response to a triggering event. Once the SNR is obtained, the communication management module 150 may analyze the SNR to determine how to handle the client device 120. In some implementations, the communication management module 150 compares the SNR with a predetermined SNR threshold to determine whether to disconnect the client device 120 or remain connected with the client device 120. Further, in some implementations, if the AP 110 has previously disconnected the client device 120, the communication management module 150 may compare the SNR with the predetermined SNR threshold as well as compare the SNR with an earlier SNR value in order to determine whether to re-disconnect the client device 120 or remain connected with the client device 120. FIGS. 2 and 3 expand further on this AP decision process.

FIG. 2 depicts an example process flow diagram for processes conducted at the AP in accordance with an implementation. In particular, FIG. 2 describes an example process in which the AP disconnects a client device with a first measured SNR below a threshold, and then in response to the client device re-connecting to the AP, re-disconnects the client device in response to determining that a second measured SNR is still below the threshold and is above a delta value when compared to the first measured SNR.

It should be readily apparent that the processes depicted in FIG. 2 (as well as FIG. 3) represents generalized illustrations, and that other processes may be added or existing processes may be removed, modified, or rearranged without departing from the scope and spirit of the present disclosure. Further, it should be understood that the processes may represent executable instructions stored on memory that may cause an AP processing device to respond, to perform actions, to change states, and/or to make decisions. Thus, the described processes may be implemented as executable instructions and/or operations provided by a memory associated with an AP and modules included therein. Alternatively or in addition, the processes may represent functions and/or actions performed by functionally equivalent circuits like an analog circuit, a digital signal processing device circuit, an application specific integrated circuit (ASIC), or other logic devices associated with an AP and modules included therein. Furthermore, FIG. 2 (as well as FIG. 3) is not intended to limit the implementation of the described implementations, but rather the figure illustrates functional information one skilled in the art could use to design/fabricate circuits, generate software, or use a combination of hardware and software to perform the illustrated processes.

The process 200 may begin at block 210, where the AP receives a first packet from a client device. As described above, this may occur via a communication interface associated with the AP As further described above, this packet may be any type of packet received from the client device including, but not limit to, association requests, re-association requests, probe requests, authentication packets, RTS packets, ACK packets, and/or data packets.

At block 220, the AP disconnects the client device in response to determining that a SNR associated with at least the first packet is below a predetermined SNR threshold. For example, if the predetermined SNR threshold is 12, the client device will be disconnected if the SNR associated with the first packet is a 10. It should be understood that the SNR associated with at least the first packet may represent the SNR of the first packet, or the average SNR of multiple packets including the first packet. This process may be conducted in response to the communication management module obtaining the SNR measurement from the measurement module and determining that it is below the predetermined SNR threshold.

At block 230, in response to the client device reconnecting to the AP after being disconnected, the AP receives a second packet from a client device. Similar to receiving the first packet, this may occur via a communication interface associated with the AP, and may be any packet received from the client device including, but not limit to, association requests, re-association requests, probe requests, authentication packets, RTS packets, ACK packets, and/or data packets.

At block 240, the AP re-disconnects the client device in response to determining that (i) a SNR associated with at least the second packet is below the predetermined SNR threshold, and (ii) the absolute difference between the SNR associated with at least the second packet and the SNR associated with at least the first packet is above a predetermined delta value. For example, if the predetermined SNR threshold is 12 and the delta value is 3, the AP will disconnect the client device for a first time in response to receiving a first SNR measurement of 10. Then, if the client device reconnects and a second SNR measurement is 4, the AP will disconnect the client device for a second time because the second SNR measurement (i.e., 4) is below the predetermined SNR threshold of 12, and the absolute value between the first SNR measurement (i.e., 10) and the second SNR measurement (i.e., 4) is 6, which is above the delta value of 4. This tends to be the case when the client reconnected in a different, further location from where the client device was previously connected.

FIG. 3 depicts an example process flow diagram 300 for processes conducted at the AP in accordance with an implementation. In particular, FIG. 3 describes an example process in which the AP evaluates packets received from the client device and determines whether to disconnect and potentially re-disconnect the device.

The process 300 may begin at block 305, when the AP receives a first packet from the client device. As described above, this may occur via a communication interface associated with the AP, and may be any type of packet received from the client device. Furthermore, it should be understood that the use of “first” is not intended to imply a sequential order or to imply that this is the very first packet received from the client device, but rather to distinguish this packet from other packets received from the client device. Hence, the terms “first packet,” “second packet,” and the like should be understood to merely distinguish between the various packets as opposed to implying a sequential order of the packets.

At block 310, the AP may obtain a SNR value associated with at least the first packet. It should be understood that the SNR associated with at least the first packet may represent the SNR of the first packet, or the average SNR of multiple packets including the first packet. The communication management module may request this SNR value from the measurement module which stores such information in a table included in or accessible by the measurement module. Such requests may be made periodically or in response to a trigger.

At block 315, the AP may determine if the SNR value associated with at least the first packet is above a predetermined SNR threshold. This process may be conducted by the communication management module, and the predetermined SNR threshold may be a default value set in the system or a user-defined value. In some implementations, this threshold may be configurable, while in other implementations the value may be non-configurable. In response to determining that the SNR value associated with at least the first packet is above a predetermined SNR threshold, the AP leaves the client device connected and continues to periodically evaluate SNR values associated with packets received from the client device. On the other hand, in response to determining that the SNR value associated with at least the first packet is below a predetermined SNR threshold, the AP disconnects the client device at block 320. In general, this may mean that the AP has determined that the SNR value associated the client device is below a desired amount, and therefore the client device should be disconnected because the client device is likely distant from the AP and may be able to connect to a closer AP after the Forced disconnect by the AP

At block 325, after the AP has disconnected the client device, the AP determines if the client device has reconnected to the AP. If not, the process is complete at block 330 because the client device likely re-connected to a different AP in response to the force disconnect by the AP However, if the client did reconnect to the AP, at block 335, the AP obtains the SNR value associated with at least a second packet received from the client device. Similar to above, the second packet may represent the SNR of only the second packet, or represent an average SNR of multiple packets including the second packet. Furthermore, similar to above, the SNR may be obtained by the communication management module from the measuring module, and such information may be stored in a table within or accessible by the measuring module.

At block 340, the AP determines if the SNR associated with at least the second packet is above a SNR threshold. Depending on the implementation, this SNR threshold may the same or different from the previously mentioned SNR threshold. If the AP determines that the SNR associated with at least the second packet is above the SNR threshold, the AP leaves the client device connected and continues to periodically evaluate SNR values associated with packets received from the client device. In general, this may be the case when the client reconnects from a location or environment that provides a better SNR than previously measured. For example, in response to being disconnected, the client device may have moved closer to the AP and therefore the SNR increased over the SNR threshold, and the AP refrained from re-disconnecting the client device.

Conversely, at block 345, in response to determining that the SNR associated with at least the second packet is below the SNR threshold, the AP determines whether the absolute difference between the SNR associated with at least the second packet and the previously determined SNR associated with at least the first packet. If the absolute difference is not above the delta value, at block 355, the AP remains connected with the client device. For example, if the SNR associated with at least the second packet is 8, the SNR associated with at least the first packet is 9, and the delta value is 3, the AP would remain connected with the client device because the absolute difference is 1 which is less than the delta value of 3. This generally may be the case when the client device reconnects from around the same area due to not having other AP options to connect to. Hence, the AP should not re-disconnect because, even though the signal quality may be poor, the client device may not have a better option.

By contrast, at block 350, if the absolute difference is above the delta value, the AP re-disconnects the client device. For example, if the SNR associated with at least the second packet is 5, the SNR associated with at least the first packet is 9, and the delta value is 3, the AP would re-disconnect the client device because the absolute difference is 4 which is greater than the delta value of 3. This generally may be the case when the client device reconnects from an area even further or in a worse environment than during the previous connection, and therefore the AP re-disconnects because communication is further degrading and the AP would prefer either for the client device to reconnect from a closer location or more suitable environment, or connect to a different AP Put another way, the AP may not be sure where the client device is located or headed, but signal quality is very low and only degrading, so the AP re-disconnects to try to force the client device to move to a better location/environment with respect to the AP, or connect with another AP

With respect to the above-mentioned delta value, it should be understood that, depending on the implementation, the above-mentioned delta value may be configurable or non-configurable. For example, the delta value may be configurable to allow an administrator to more easily accommodate reconnection (i.e., have a higher delta value), or more restrictive to discourage re-connection (i.e., have a lower delta value). This delta value as well as the above mentioned SNR threshold(s) may be configurable via a user interface associated with the AP.

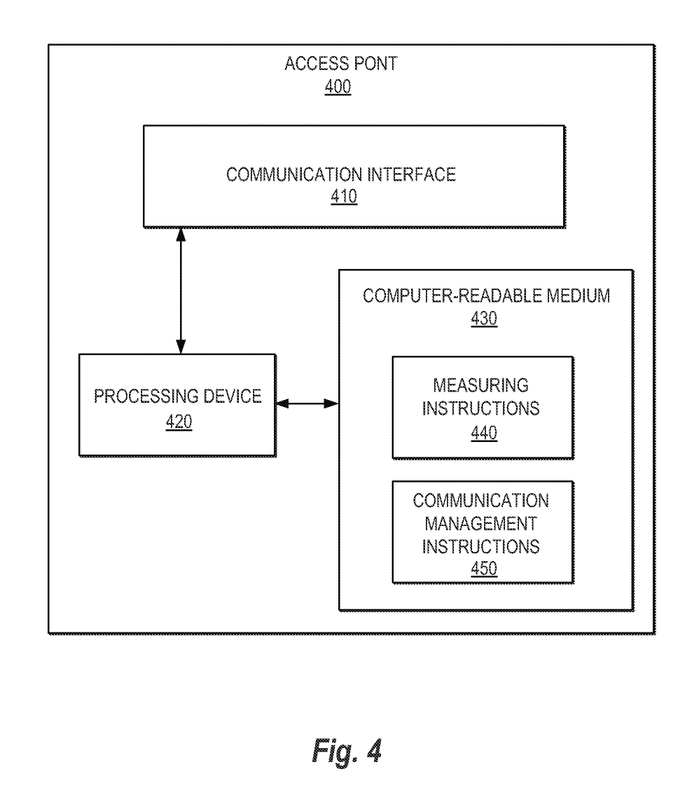

FIG. 4 depicts an example AP 400 in accordance with an implementation. The AP may comprise a communication interface 410, a processing device 420, and a computer-readable medium 430 communicatively coupled to each other. The communication interface 410 may comprise, for example, ports, PHYs, transmitters, receivers, and/or transceivers. As discussed above, the communication interface 410 may, among other things, receive packets from a client device. The processing device 420 may be a at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on the computer-readable storage medium 430, or a combination thereof. In particular, the processing device 430 may fetch, decode, and execute instructions stored on the computer-readable storage medium 430 to implement the functionalities described above. The computer-readable storage medium 430 may correspond to any typical storage device that stores machine-readable instructions, such as programming code, software, firmware, or the like. For example, the computer-readable storage medium 430 may include one or more of a non-volatile memory, a volatile memory, and/or a storage device. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. In some implementations, the instructions may be part of an installation package that can be executed by the processing device 420. In this case, the computer-readable medium 430 may be a portable medium such as a CD, DVD, or flash drive or a memory maintained by a server from which the installation package can be downloaded and installed. In another implementation, the instructions may be part of an application or application already installed. Here, the computer-readable storage medium 430 may include integrated memory such as a hard drive.

Among other things, the computer-readable storage medium 430 may comprise measuring instructions 440 and communication management instructions 450. When executed by the processing device 420, the measuring instructions cause the AP 400 to measure a SNR of a packet. The result may then be stored in a table resident on the computer-readable storage medium 430, or in another accessible memory. Furthermore, when executed by the processing device 420, the communication management instructions 450 may cause the AP 400 to obtain SNR values and determine whether a client device should be disconnected based thereon.

The foregoing describes a novel and previously unforeseen AP implementation that attempts to forces client devices to connect to closer APs even if the client device refrains from scanning other channels until a signal from the AP is dropped or not reachable anymore. While the above disclosure has been shown and described with reference to the foregoing examples, it should be understood that other forms, details, and implementations may be made without departing from the spirit and scope of the disclosure that is defined in the following claims.

What is claimed is:

1. An access point comprising:
a communication interface to receive a packet from a client device which was previously disconnected from the access point and has re-connected to the access point;
a measuring module to measure a signal-to-noise ratio (SNR) of the packet; and
a communication management module to:
obtain the SNR of the packet from the measuring module; and
if the SNR of the packet is above a predetermined SNR threshold, continue communication with the client device;
if the SNR of the packet is below the predetermined SNR threshold, and if the absolute difference between the SNR of the packet and an earlier SNR is less a predetermined delta value, continue communication with the client device; and
if the SNR of the packet is below the predetermined SNR threshold, and if the absolute difference between the SNR of the packet and the earlier SNR is above a predetermined delta value, disconnect the client device from the access point.

2. The access point of claim 1, wherein the client device was previously disconnected from the access point because the earlier SNR was below the predetermined SNR threshold.

3. The access point of claim 1, wherein the communication management module is to periodically request SNR information from the measuring module.

4. The access point of claim 1, wherein the measuring module is further to measure the SNR of each packet received from the client device.

5. The access point of claim 1, wherein the measuring module is further to store the earlier SNR and the SNR of the packet.

6. The access point of claim 1, wherein the client device is at least one of a tablet, laptop, and smartphone.

7. The access point of claim 1, wherein the client device is a wireless communication device.

8. A method comprising:
receiving, at an access point, a first packet from a client device;
disconnecting, by the access point, the client device in response to determining that a signal-to-noise ratio (SNR) associated with at least the first packet is below a predetermined SNR threshold;
receiving, at an access point, a second packet from the client device in response to the client device re-connecting with the access point;
disconnecting, by the access point, the client device in response to determining that
(i) a SNR associated with at least the second packet is below the predetermined SNR threshold, and
(ii) the absolute difference between the SNR associated with at least the second packet and the SNR associated with at least the first packet is above a predetermined delta value.

9. The method of claim 8, further comprising:
continuing communication, by the access point with the client device, in response to determining that
(i) the SNR associated with at least the second packet is below the predetermined SNR threshold, and
(ii) the absolute difference between the SNR associated with at least the second packet and the SNR associated with at least the first packet is less than the predetermined delta value.

10. The method of claim 8, further comprising:
continuing communication with the client device, by the access point, in response to determining that the SNR associated with at least the second packet is above the predetermined SNR threshold.

11. The method of claim 8, wherein the client device is at least one of a tablet, laptop, and smartphone.

12. The method of claim 8, further comprising:
storing, by the access point, at least one of the SNR associated with at least the first packet and the SNR associated with at least the second packet.

13. The method of claim 8, wherein at least one of the SNR associated with at least the first packet and the SNR associated with at least the second packet is an average SNR value based on a plurality of SNR measurements.

14. A non-transitory computer-readable medium comprising instructions that when executed cause an access point to:
compare a measured SNR associated with at least a first packet with a predetermined SNR threshold;
disconnect the client device in response to determining that the measured SNR associated with at least the first packet is below the predetermined SNR threshold;
compare a measured SNR associated with at least a second packet with the predetermined SNR threshold, wherein the second packet is received from the client device in response to the client device re-connecting with the access point;
disconnect the client device in response to determining that
(i) the measured SNR associated with at least the second packet is below the predetermined SNR threshold, and
(ii) the absolute difference between the measured SNR associated with at least the second packet and the SNR associated with at least the first packet is above a predetermined delta value.

15. The non-transitory computer-readable medium of claim 14, comprising further instructions that when executed cause the access point to:
continue communication with the client device in response to determining that
(i) the measured SNR associated with at least the second packet is below the predetermined SNR threshold, and
(ii) the absolute difference between the measured SNR associated with at least the second packet and the SNR associated with at least the first packet is less than a predetermined delta value.

16. The non-transitory computer-readable medium of claim 14, comprising further instructions that when executed cause the access point to:
continue communication with the client device in response to determining that the measured SNR associated with at least the second packet is above the predetermined SNR threshold.

17. The non-transitory computer-readable medium of claim 14, comprising further instructions that when executed cause the access point to:
continue communication with the client device in response to determining that the measured SNR associated with at least the first packet is above the predetermined SNR threshold

18. The non-transitory computer-readable medium of claim 14, wherein the client device is at least one of a tablet, laptop, and smartphone.

19. The non-transitory computer-readable medium of claim 14, comprising further instructions that when executed cause the access point to store the SNR associated with at least a first packet and the SNR associated with at least the second packet.

20. The non-transitory computer-readable medium of claim 14, wherein at least one of the SNR associated with at least the first packet and the SNR associated with at least the second packet is an average SNR value based on a plurality of SNR measurements.
